(19) United States
(12) Patent Application Publication
(10) Pub. No.: US 2025/0071067 A1
(43) Pub. Date: Feb. 27, 2025

(54) APPARATUS AND METHOD FOR MANAGING PRIORITY IN MEMORY DISAGGREGATION NETWORK

(71) Applicant: ELECTRONICS AND TELECOMMUNICATIONS RESEARCH INSTITUTE, Daejeon (KR)

(72) Inventor: Jong Tae SONG, Daejeon (KR)

(21) Appl. No.: 18/810,942

(22) Filed: Aug. 21, 2024

(30) Foreign Application Priority Data
Aug. 24, 2023 (KR) 10-2023-0111259

(51) Int. Cl. H04L 47/52; H04L 47/62

(52) U.S. Cl. CPC H04L 47/52; H04L 47/6215

(57) ABSTRACT

According to an embodiment of the present disclosure, a computer implementation method using a device for managing a priority in a memory disaggregation network, the computer implementation method comprising: classifying received read requests by priority and storing the read requests in a request queue of a memory module; classifying the received read requests by response path indicating an output port of the memory module and storing the read requests in a response queue of the memory queue; and performing scheduling in consideration of states of the request queue and response queues.

### CROSS-REFERENCE TO RELATED APPLICATION

The present application claims priority to Patent Application No. 10-2023-0111259, filed on in Korea Intellectual Property Office on Aug. 24, 2023, the entire contents of which are incorporated herein by reference.

### TECHNICAL FIELD

The present disclosure relates to an apparatus and method for managing a priority in a memory disaggregation network.

### BACKGROUND

The content to be described below simply provides background information related to the present embodiment and does not constitute the related art.

A cloud computing structure is evolving from a homogeneous computing structure in which performance of a central processing unit (CPU) is important to a heterogeneous computing structure in which fast data exchange between specialized engines is important. With the evolvement to the heterogeneous computing structure, a data center network is evolving from a structure that servers are connected to a disaggregation technology for connecting cloud resources such as CPUs, memories, accelerators, and storages.

An issue of a computing resource disaggregation technology is to speed up connections between resources while distributing the resources so that application performance is not degraded. An ultimate goal is to provide a connection delay and bandwidth between the resources at the same physical server level. In the case of accelerators and the storages, even when a resource pool is configured using electrical switches, a required delay and bandwidth can be satisfied and there is no performance degradation. On the other hand, in the case of the memories, guaranteeing of a 1 μs delay and 100 Gbps bandwidth is required to minimize performance degradation, and support of such a delay and bandwidth cannot be solved with electrical switches, and application of optical switches is essential.

In particular, it is expected that an optical-based connection will be needed to support a high bandwidth memory (HBM) which requires a bandwidth of several Tbps in the future. Accordingly, various research institutes are actively researching a memory disaggregation technology using optical switches. Through an optical-based memory disaggregation technology, current storage-level disaggregation can be extended to a memory.

In an optical-based memory disaggregation network, when large amounts of data are simultaneously read for high-priority traffic and low-priority traffic, a situation where a high-priority response path is always overloaded and a low-priority response path is always underloaded occurs. Accordingly, when priority scheduling is applied in the optical-based memory disaggregation network, a problem of an excessive quality degradation occurs in the low priority.

### SUMMARY

The present disclosure provides an apparatus and method for solving a problem of excessive quality degradation in a low priority expected when priority scheduling is applied in an optical-based memory disaggregation network.

The present disclosure provides an apparatus and method for deriving a maximum number of priorities that can be supported without performance degradation in a memory module of an optical-based memory disaggregation network.

The problems to be solved by the present invention are not limited to the problems mentioned above, and other problems not mentioned can be clearly understood by those skilled in the art from the description below.

According to an embodiment of the present disclosure, a computer implementation method using a device for managing a priority in a memory disaggregation network, the computer implementation method comprising: classifying received read requests by priority and storing the read requests in a request queue of a memory module; classifying the received read requests by response path indicating an output port of the memory module and storing the read requests in a response queue of the memory queue; and performing scheduling in consideration of states of the request queue and response queues.

According to an embodiment of the present disclosure, a device for managing a priority in a memory disaggregation network, the device comprising: a memory configured to store instructions; and a processor configured to execute the instructions to thereby classify received read requests by priority and store the read requests in a request queue of a memory module, classify the received read requests by response path indicating an output port of the memory module and store the read requests in a response queue of the memory queue, and perform scheduling in consideration of states of the request queue and response queues.

With the present disclosure, it is possible to cope with a case where a current board-level disaggregation structure is extended to an inter-rack level.

With the present disclosure, it is possible to provide differential services depending on service importance when a computing engine uses a disaggregated memory.

With the present disclosure, it is possible to prevent excessive performance degradation of low-priority traffic, which is a problem when differential services are provided, and to improve overall performance.

The effects of the present disclosure are not limited to the effects mentioned above, and other effects not mentioned may be clearly understood by those skilled in the art from the description below.

### BRIEF DESCRIPTION OF THE DRAWINGS

FIG. 1 is a structural diagram of a general optical-based memory disaggregation network.

FIG. 2 is a structural diagram of a device for managing a priority in a memory disaggregation network according to an embodiment of the present disclosure.

FIG. 3 is a flowchart showing a priority scheduling method for a device for managing a priority in the memory disaggregation network according to the embodiment of the present disclosure.

FIG. 4 is a flowchart showing a detailed priority scheduling method in the device for managing a priority in the memory disaggregation network according to the embodiment of the present disclosure.

FIG. 5 is an illustrative diagram showing parameters applied to the embodiment of the present disclosure.

FIGS. 6A, 6B, and 6C are illustrative diagrams showing analysis results obtained by comparing performance of a priority-based scheduling method according to an embodiment of the present disclosure with performance of an existing method.

### DETAILED DESCRIPTION

Hereinafter, some embodiments of the present disclosure will be described in detail with reference to the accompanying drawings. In the following description, like reference numerals can designate like elements, even though the elements can be shown in different drawings. Further, the following description of some embodiments can omit, for the purpose of clarity and for brevity, a detailed description of related known components and functions when considered obscuring the subject of the present disclosure.

Various ordinal numbers or alpha codes such as “first”, “second”, “A”, “B”, “(a)”, “(b)”, etc., can be prefixed solely to differentiate one component from the other but not to necessarily imply or suggest the substances, order, or sequence of the components. Throughout this specification, when a part “includes” or “comprises” a component, the part is meant to allow for further including other components and to not exclude other components, unless specifically stated to the contrary. Terms such as “unit,” “module,” and the like can refer to units in which at least one function or operation is processed and they may be implemented by hardware, software, or a combination thereof.

In the present specification, mapping rule and rule have the same meaning, so they will be used interchangeably.

The following detailed description is intended to describe exemplary embodiments of the present invention and is not intended to represent the only embodiments in which the present invention may be practiced.

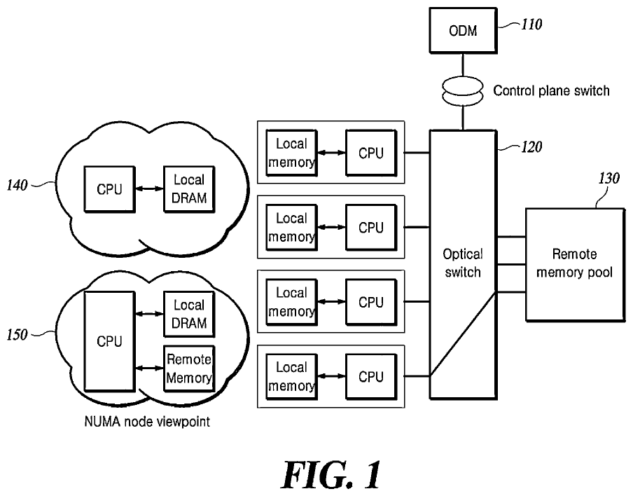

FIG. 1 is a structural diagram of a general optical-based memory disaggregation network.

A cloud computing structure is evolving from a homogeneous computing server-centered structure where CPU performance is important to a heterogeneous computing resource-centered structure where fast data exchange between specialized computing engines is important. Accordingly, a data center network is evolving from a structure in which servers are connected to a disaggregation technology for connecting cloud resources such as a CPU, a memory, an accelerator, and storage.

In an optical-based memory disaggregation network, several servers share physically disaggregated memory resources, as shown in FIG. 1. Overall resource management is performed through an optical disaggregation manager (ODM) 110, and in the case of a CPU that requires additional memory resources, the CPU is connected to memory resources (a remote memory pool 130) through an optical switch 120. As shown in FIG. 1, in the case of the server 140 that is not connected to a memory through an optical connection, only a nearby memory (a local memory in FIG. 1) can be utilized, whereas in the case of a server 150 connected to a remote memory through an optical connection, the remote memory can also be used in addition to the nearby memory as a system memory. The remote memory connected in this way is recognized and managed as a separate non-uniform memory access (NUMA) node and performs the same functions as the nearby memory. As a result, a memory capacity of the server can increase.

A disaggregated memory is developing into a multi logical device (MLD) form in which a plurality of hosts share memory resources. In an MLD memory, addresses are divided into ranges, which are used as a memory by each host. The MLDs and hosts may be connected through switches to constitute various forms. In the MLD, QoS control may be provided in various ways. A weighted fair queueing (WFQ) method in which scheduling is performed through allocation of a bandwidth to each class is also possible, but in this case, since bandwidth prediction is difficult and control such as having to change scheduling parameters depending on a situation is complicated, the WFQ method is inappropriate to apply to memory access that requires high-speed processing. In an embodiment of the present disclosure, when a memory disaggregated between hosts is accessed, the priority is determined depending on an application service and scheduling is performed, so that a control structure is simplified.

However, when a read request received from the memory module is simply processed on the basis of a priority, the performance of low priority traffic is degraded more than necessary. In particular, memory reading has characteristics that a request message size is small, but a response message size is large. Further, a memory bandwidth in the memory module is larger than a bandwidth of a network connected via an optical link. Therefore, when large amounts of data are simultaneously read for high-priority traffic and low-priority traffic, a situation where a high-priority response path is always overloaded, whereas a low-priority response path is always underloaded occurs.

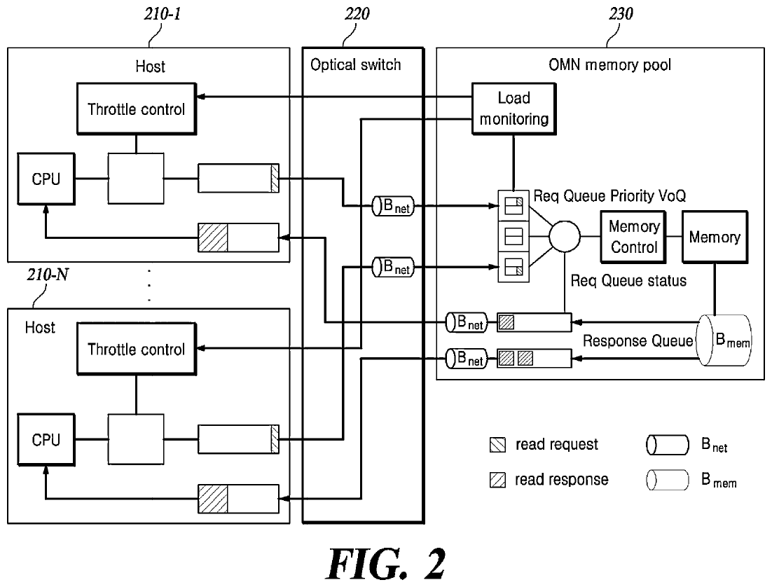

FIG. 2 is a structure diagram of the device for managing a priority in the memory disaggregation network according to an embodiment of the present disclosure.

A memory module scheduling structure for solving the above-described problem will be described with reference to FIG. 2. FIG. 2 shows a case where several hosts 210-1 to 210-N access a common memory module (OMN memory pool) 230 through an optical switch 220 to read or write data. In this structure, the following three types of scheduling and flow control are required.

Credit-based flow control per host: Each host limits a total number of requests through window base flow control. That is, when an initial window size is 30, the number of credits is set to 30 and a maximum number of requests can be sent without a response.

Priority-based rate throttling: Traffic for each priority is controlled by a load of each traffic on the memory module. That is, when a load of a specific priority request is as high as possible, the host is requested to limit traffic with the priority, and the host adjusts a requested amount in consideration of a priority-specific load received from the memory module (throttle control)

Priority scheduling: In the memory module, received read requests are classified by priority and processed starting from the highest priority request.

The embodiment of the present disclosure defines a priority scheduling structure that is a third element in detail.

The received read request is stored in a priority virtual output queue (VoQ) organized for (1) priority and (2) response path. That is, the priority VoQ classifies read requests by priority and by response path, which is an output port of the memory module, and stores the read requests.

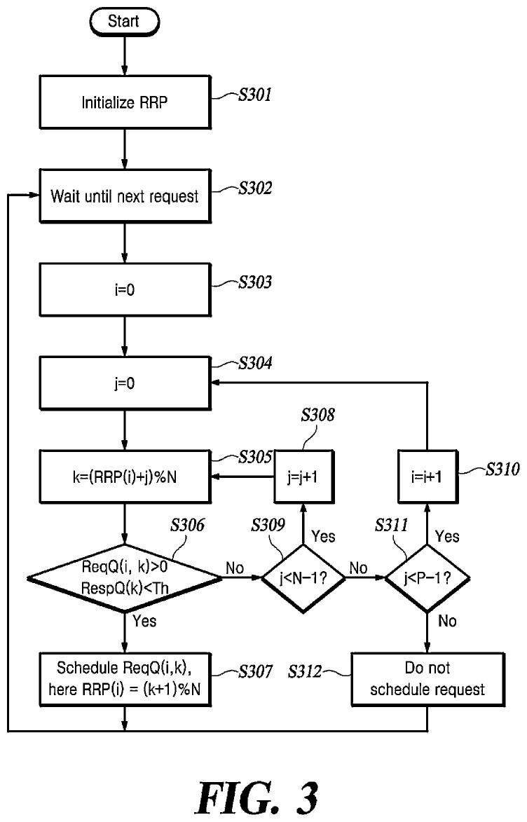

FIG. 3 is a flowchart showing a priority scheduling method in a device for managing a priority in the memory disaggregation network according to the embodiment of the present disclosure.

First, the device for managing a priority in the memory disaggregation network performs RRP (round robin pointer) initialization in step 301. For example, the device for managing a priority in the memory disaggregation network sets RRP (i)=0. Here, i is 0, 1, 2, . . . , P-1. RRP (i) represents an RRP of priority i. When the number of scheduling requests is two or more, round robin-based scheduling is performed.

The device for managing a priority in the memory disaggregation network waits until the next request in step 302.

The device for managing a priority in the memory disaggregation network sets priority i to 0 in step 303 and sets output port j to 0 in step 304. Here, i represents a priority index, i=0, 1, 2, . . . , P-1, and j is an index of the output port, j=0, 1, 2, . . . , N-1.

The device for managing a priority in the memory disaggregation network may set an output port k to (RRP(i)+j) % N in step 305. Here, k can be expressed as k=0,1, 2, . . . , N-1.

In step 306, the device for managing a priority in the memory disaggregation network determines whether the request queue ReqQ(i,k) is greater than 0 and the the response queue ResQ(k) is smaller than a threshold.

When the request queue ReqQ(i,k) is greater than 0 and the response queue ResQ(k) is smaller than the threshold, the device for managing a priority in the memory disaggregation network may perform scheduling as ReqQ(i,k) and RRP(i)=(k+1)% N in step 307. That is, when the request queue ReqQ(i,k) is greater than 0 and the response queue ResQ(k) is smaller than the threshold, the device for managing a priority in the memory disaggregation network may perform scheduling with a surplus bandwidth even when the priority is low.

In the case of existing priority scheduling, scheduling is performed on the basis of a status of the request queue ReqQ(i,k) which consists of priority i and output j. However, in the case of scheduling according to the embodiment of the present disclosure, scheduling may be performed in consideration of the status of the response queue RespQ(j) along with the request queue ReqQ(i,k).

On the other hand, when the request queue ReqQ(i,k) is smaller than 0 and the the response queue ResQ(k) is equal to or greater than the threshold in step 306, the device for managing a priority in the memory disaggregation network determines whether j is smaller than N-1 in step 309.

When j is smaller than N-1, the device for managing a priority in the memory disaggregation network sets j=j+1 in step 308 and proceeds to step 305.

On the other hand, when j is equal to or greater than N-1, the device for managing a priority in the memory disaggregation network determines whether j is smaller than P-1 in step 311.

When j is smaller than P-1, the device for managing a priority in the memory disaggregation network sets i=I 30 1 and proceeds to step 304.

On the other hand, when j is equal to or greater than P-1, the device for managing a priority in the memory disaggregation network does not perform scheduling on requests in step 312.

In summary, the device for managing a priority in the memory disaggregation network does not perform scheduling even when the priority is high when a size of a response queue is larger than a certain threshold, as in step 306 of FIG. 3. Through this, a surplus bandwidth is used for processing of a low priority request, making it possible to improve performance not only for higher priorities but also for excessively lowered lower priorities. In the case of high-priority traffic, since the response queue is already overloaded and 100% of a bandwidth of a response path will be utilized for a certain period of time, degradation in performance of the high-priority traffic does not occur unlike an existing scheme even when the surplus bandwidth is used to process low-priority traffic.

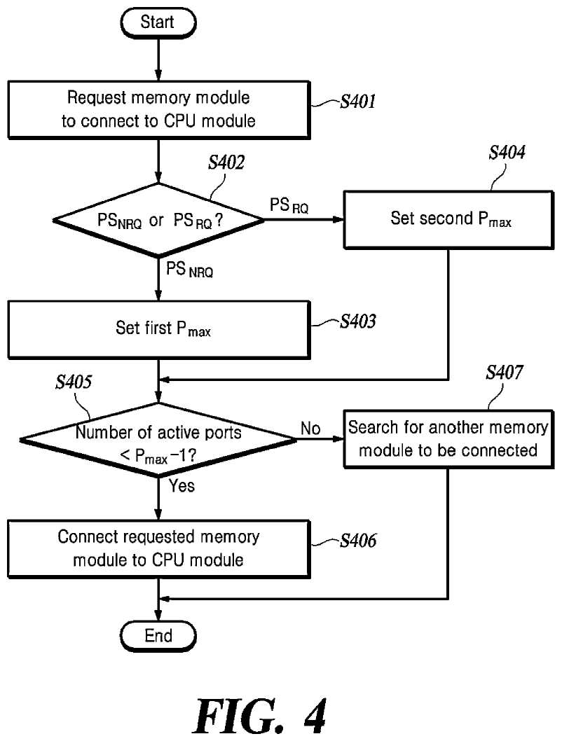

Before FIG. 4 is described, system parameters in the memory disaggregation network to be described with reference to FIG. 4 may be defined as shown in Table 1 below.

TABLE 1

| Parameter | Definition |
|---|---|
| S_{req} | size of request message (bits) |
| Sᵣₑₛₚ | size of response message (bits) |
| Bₘₑₘ | Bandwidth for memory interface (Gbps) |
| Bₙₑₜ | Bandwidth for network interface (Gbps) |

S_{req} represents a size of the request message stored in the request queue, and Sᵣₑₛₚ represents a size of the response message stored in the response queue. FIG. 4 is a flowchart showing a detailed priority scheduling method in the device for managing a priority in the memory disaggregation network according to the embodiment of the present disclosure.

The device for managing a priority in the memory disaggregation network may request the memory module to connect to the CPU module in step 401.

The device for managing a priority in the memory disaggregation network determines PS_{NRQ} or PS_{RQ} in step 402.

In the case of PS_{NRQ}, the device for managing a priority in the memory disaggregation network may set Pₘₐₓ (first Pₘₐₓ in FIG. 4) as shown in Equation 1 in step 403.

Pₘₐₓ represents the number of priorities that can be supported without performance degradation at the time of priority scheduling. When the response queue is not checked (PS_{NRQ} scheme−existing scheme), Pₘₐₓ can be expressed as shown in Equation 1 below.

$${P}_{max} = ⌈ \frac{{B}_{mem} / {B}_{net}}{{S}_{resp} / {S}_{req}} ⌉ = ⌈ \frac{{T}_{req}}{{T}_{mem}} ⌉ \qquad [ Equation 1 ]$$

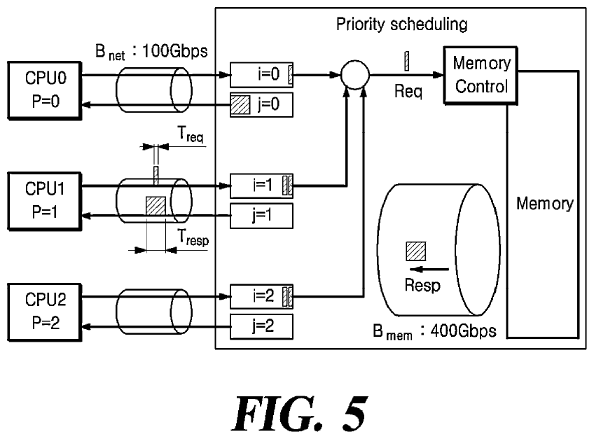

Parameters of Equation 1 will be described with reference to FIG. 5.

FIG. 5 is an illustrative diagram showing parameters applied to an embodiment of the present disclosure.

S_{req} represents the size of the request message stored in the request queue, Sᵣₑₛₚrepresents a size of the response message stored in the response queue, and Bₘₑₘrepresents a bandwidth in case of a memory interface. More specifically, Bₘₑₘrepresents a memory bandwidth when response data (that is, the response message) is read from a memory in the OMN memory pool 230 of FIG. 2, and in FIG. 5, Bₘₑₘ is, for example, 400 Gbps. Bₘₑₘ is hereinafter referred to as a “memory bandwidth.”

Bₙₑₜ represents a bandwidth in the case of a network interface, and in FIG. 5, Bₙₑₜ is, for example, 100 Gbps. Bnet is hereinafter referred to as a “network bandwidth.”

T_{req} represents a transmission time taken to transfer the request message using the network bandwidth (T_{req}=S_{req}/Bₙₑₜ).

Tₘₑₘ represents a transmission time taken to transfer the response message using the memory bandwidth (Tₘₑₘ=Sᵣₑₛₚ/Bₘₑₘ).

For reference, in FIG. 5, Tresp represents the transmission time taken to transfer the response message using the network bandwidth.

In the case of PS_{RQ}, the device for managing a priority in the memory disaggregation network may set Pₘₐₓ as shown in Equation 2 in step 404.

When the response queue (PS_{RQ} scheme) is considered according to the embodiment of the present disclosure, Pₘₐₓ (second Pₘₐₓ in FIG. 4) is expressed as shown in Equation 2 below.

$${P}_{max} = ⌈ \frac{{B}_{mem}}{{B}_{net}} ⌉ \qquad [ Equation 2 ]$$

Comparing the two cases (steps 403 and 404), a Pₘₐₓ value when the response queue is considered (PS_{RQ}) under the same conditions is greater than that when the response queue is not considered (PS_{NRQ}). For example, when Sᵣₑₛₚ/S_{req}=4 and Bₘₑₘ/Bₙₑₜ=4, Pₘₐₓ=1 in PS_{NRQ}, while Pₘₐₓ=4 in a PS_{RQ} scheme. It can be seen that in the PS_{RQ} scheme, the Pₘₐₓ value increases proportionally as the memory bandwidth increases, whereas in the PS_{NRQ} scheme, even when the memory bandwidth increases, the Pₘₐₓ value does not increase if a ratio of the response message size to the request message size (Sᵣₑₛₚ/S_{req}) increases to the same level.

In priority-based scheduling, in order to prevent overall performance from being degraded, connection control may be performed so that the performance degradation does not occur, by using the scheme shown in FIG. 4. In other words, Pₘₐₓ according to the scheduling scheme in the memory module is calculated, and the connection control is performed so that the number of CPU modules is included in a range that does not exceed Pₘₐₓ.

Meanwhile, after steps 403 and 404, the device for managing a priority in the memory disaggregation network determines whether the number of active ports is smaller than Pₘₐₓ-1 in step 405.

When the number of active ports is smaller than Pₘₐₓ-1, the device for managing a priority in the memory disaggregation network may connect a requested memory module to the CPU module in step 406. That is, the device for managing a priority in the memory disaggregation network may connect the memory module to the CPU module within the range that does not exceed Pₘₐₓ.

On the other hand, when the number of active ports is greater than Pₘₐₓ-1, the device for managing a priority in the disaggregation network searches for another memory module to be connected in step 407.

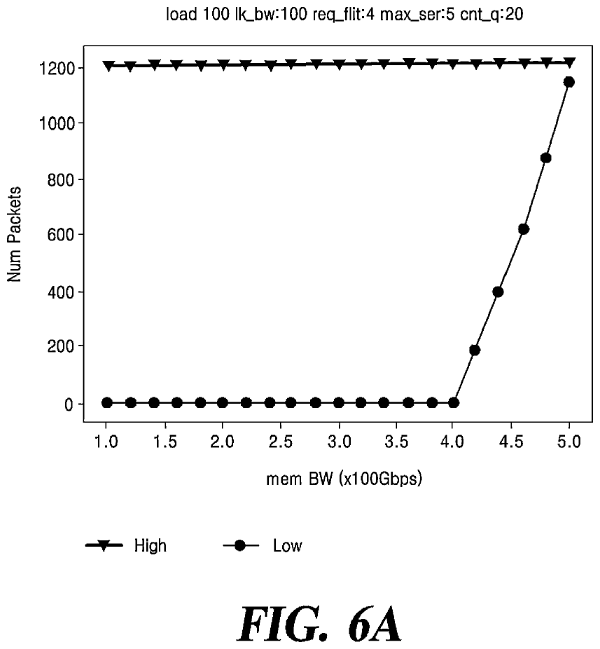

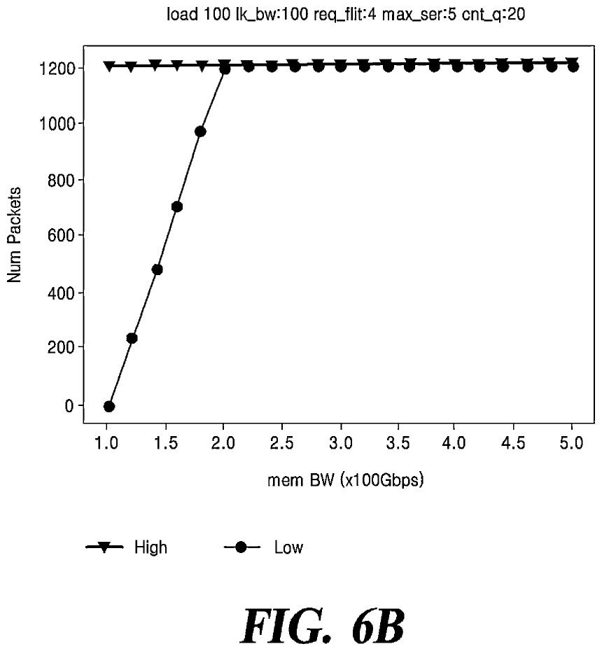

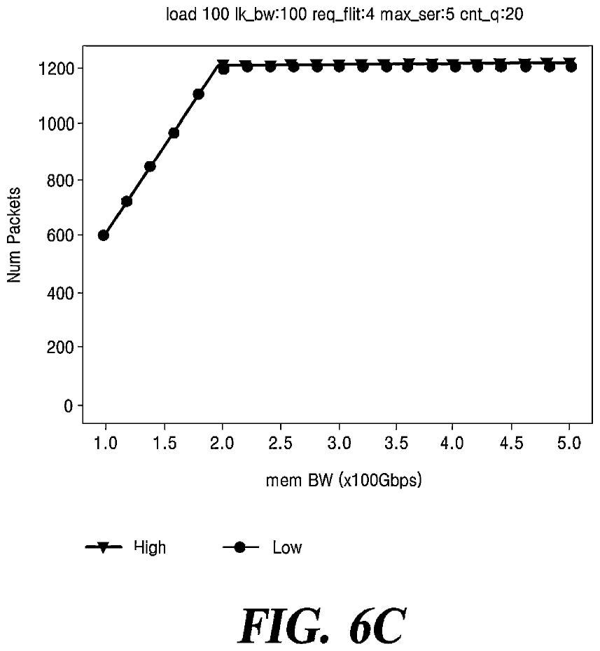

FIGS. 6A, 6B, and 6C are illustrative diagrams showing analysis results obtained by comparing the performance of a priority-based scheduling method according to the embodiment of the present disclosure with the performance of an existing method.

It can be seen from FIGS. 6A, 6B, and 6C how many read responses the high priority host and the low priority host receive during the same time. FIGS. 6A, 6B, and 6C show that, when the network bandwidth is 100 Gbps, amounts of data received as a response while the memory bandwidth is changed from 100 Gbps to 500 Gbps can be compared.

FIG. 6A is an illustrative diagram showing performance when existing priority-based scheduling is applied.

FIG. 6B is an illustrative diagram showing performance when the priority scheduling according to the embodiment of the present disclosure is performed.

As can be seen from FIG. 6B, in a case where the priority scheduling according to the embodiment of the present disclosure is performed, all priority traffics can achieve 100% of performance when the memory bandwidth is 200 Gbps. However, as can be seen from FIG. 6B, in a case where the existing priority-based scheduling is performed, the memory bandwidth must be increased to 500 Gbps so that all the priority traffics can achieve 100% of performance.

Further, when the priority scheduling according to the embodiment of the present disclosure is performed, low-priority traffic can be processed at a memory bandwidth of 100 Gbps or more, but when the existing priority-based scheduling is performed, completely low-priority traffic cannot be processed at 400 Gbps or less.

FIG. 6C shows a case where scheduling is performed without priority, and shows worse results than those when the existing priority-based scheduling of FIG. 6A is applied. As a result, simple priority scheduling excessively limits the low-priority traffic, leading to degradation in overall system throughput performance, whereas when the scheduling method according to the embodiment of the present disclosure is used, it is possible to improve the performance of the low-priority traffic without degradation in the performance of the high-priority traffic.

With the present disclosure, it is possible to cope with a case where a current board-level disaggregation structure is extended to an inter-rack level. With the present disclosure, it is possible to provide differential services depending on service importance when a computing engine uses the memory disaggregation. With the present disclosure, it is possible to prevent excessive performance degradation of the low-priority traffic, which is a problem when the differential services are provided, and to improve the overall performance.

At least some of the components described in the exemplary embodiments of the present disclosure can be implemented as a hardware element including at least one or a combination of a digital signal processor (DSP), a processor, a network control unit, an application-specific IC (ASIC), a programmable logic device (FPGA or the like), and other electronic devices. Further, at least some of the functions or processes described in the exemplary embodiments may be implemented as software, and the software may be stored in a recording medium. At least some of the components, functions, and processes described in the exemplary embodiments of the present disclosure may be implemented through a combination of hardware and software.

The method according to the exemplary embodiments of the present disclosure can be written as a program that can be executed on a computer, and can also be implemented as various recording media such as a magnetic storage medium, an optical readable medium, and a digital storage medium.

Implementations of various technologies described herein may be implemented in digital electronic circuitry or in computer hardware, firmware, software, or combinations thereof. The implementations may be implemented as a computer program tangibly embodied in a computer program product, that is, an information carrier such as a machine-readable storage device (computer-readable medium) or a radio signal, for processing using an operation of a data processing device such as a programmable processor, a computer, or a plurality of computers or for control of the operation. Computer programs such as the computer program(s) described above may be written in any form of programming language, including compiled or interpreted languages, and may be deployed in any form included as a stand-alone program or as a module, component, subroutine, or other units suitable for use in a computing environment. The computer program may be deployed to be processed on one computer or a plurality of computers at one site or distributed across a plurality of sites and interconnected by a communications network.

Examples of a processor suitable for processing of the computer program include both general-purpose and special-purpose microprocessors, and any one or more processors of any type of digital computer. Typically, a processor will receive instructions and data from a read-only memory, a random access memory, or both. Elements of the computer may include at least one processor that executes instructions, and one or more memory devices that store instructions and data. Generally, a computer may include one or more mass storage devices that store data, such as magnetic disk, a magneto-optical disk, or an optical disc, or may be combined to receive data from the mass storage devices, transmit data to the mass storage devices, or perform both. Examples of information carriers suitable for embodying of computer program instructions and data include semiconductor memory devices, for example, a magnetic medium such as a hard disk, a floppy disk, and a magnetic tape, an optical medium such as a compact disk read only memory (CD-ROM) and a digital video disc (DVD), a magneto-optical medium such as a floptical disk, a read only memory (ROM), a random access memory (RAM), a flash memory, an erasable programmable ROM (EPROM), and an electrically erasable programmable ROM (EEPROM). The processor and the memory may be supplemented by or included in special purpose logic circuitry.

The processor can execute an operating system and software applications that are executed on the operating system. Further, a processor device may access, store, manipulate, process, and generate data in response to the execution of software. For ease of understanding, the processor device may be described as being used as a single processor device, but those skilled in the art will understand that the processor device includes a plurality of processing elements and/or a plurality of types of processing elements. For example, the processor device may include a plurality of processors or one processor and one network controller. Further, other processing configurations, such as parallel processors, are possible.

Further, a non-transitory computer-readable medium can be any available medium that can be accessed by a computer and includes both a computer storage medium and a transmission medium.

Although the present specification contains details of a large number of specific implementations, these should not be construed as limitations on the scope of any invention or what may be claimed, but rather as description of characteristics that may be unique to a specific embodiment of a specific invention. Specific characteristics described herein in the context of individual embodiments may also be implemented in combination in a single embodiment. On the other hand, various characteristics described in the context of a single embodiment can also be implemented in a plurality of embodiments individually or in any suitable sub-combination. Furthermore, although characteristics may operate in a specific combination and may be described as initially claimed, one or more characteristics from a claimed combination may be excluded from the combination in some cases, and the claimed combination may be changed to a sub-combination or a variant of a sub-combination.

Similarly, although operations are described in the drawings in a specific order, this should not be construed as such operations having to be performed in the shown specific or sequential order or all of shown operations having to be performed in order to obtain desirable results. In a specific case, multitasking and parallel processing may be advantageous. Further, disaggregation of various device components in the above-described embodiments should not be construed as being required in all the embodiments, and it is to be understood that the described program components and devices may generally be integrated together into a single software product or packaged into a plurality of software products.

What is claimed is:

1. A computer implementation method using a device for managing a priority in a memory disaggregation network, the computer implementation method comprising:
classifying received read requests by priority and storing the read requests in a request queue of a memory module;
classifying the received read requests by response path indicating an output port of the memory module and storing the read requests in a response queue of the memory queue; and
performing scheduling in consideration of states of the request queue and response queues.

2. The method of claim 1, wherein the performing of the scheduling includes not performing the scheduling on the request when a size of the response queue is greater than a predetermined threshold.

3. The method of claim 1, wherein the number (Pₘₐₓ) of priorities considering the response queue is expressed as shown in the following equation
$${P}_{max} = ⌈ \frac{{B}_{mem}}{{B}_{net}} ⌉ \qquad [ Equation ]$$
Bₘₑₘ represents a memory bandwidth, and
Bₙₑₜ represents a network bandwidth.

4. The method of claim 3, wherein the performing of the scheduling includes connecting the memory module to the CPU module on the basis of the number of priorities.

5. The method of claim 3, wherein the performing of the scheduling includes connecting the memory module to the CPU module when the number of output ports is smaller than Pₘₐₓ.

6. The method of claim 1, wherein the request queue and the response queue include a virtual output queue (VoQ).

7. The method of claim 1, wherein the number (Pₘₐₓ) of priorities without considering the response queue is expressed as shown in the following equation,
$${P}_{max} = ⌈ \frac{{B}_{mem} / {B}_{net}}{{S}_{resp} / {S}_{req}} ⌉ = ⌈ \frac{{T}_{req}}{{T}_{mem}} ⌉ \qquad [ Equation ]$$
S_{req} represents a size of the request message stored in the request queue,
Sᵣₑₛₚ represents a size of the response message stored in the response queue,
Bₘₑₘ represents a memory bandwidth,
Bₙₑₜ represents a network bandwidth,
T_{req} represents a transmission time taken to transfer the request message using the network bandwidth (T_{req}=S_{req}/Bₙₑₜ), and
Tₘₑₘ represents a transmission time taken to transfer the response message using the memory bandwidth (Tₘₑₘ=Sᵣₑₛₚ/Bₘₑₘ).

8. A device for managing a priority in a memory disaggregation network, the device comprising:
a memory configured to store instructions; and
a processor configured to execute the instructions to thereby classify received read requests by priority and store the read requests in a request queue of a memory module, classify the received read requests by response path indicating an output port of the memory module and store the read requests in a response queue of the memory queue, and perform scheduling in consideration of states of the request queue and response queues.

9. The device of claim 8, wherein the scheduling is not performed on the request when a size of the response queue is greater than a predetermined threshold.

10. The device of claim 8, wherein the number (Pₘₐₓ) of priorities considering the response queue is expressed as shown in the following equation
$${P}_{max} = ⌈ \frac{{B}_{mem}}{{B}_{net}} ⌉ \qquad [ Equation ]$$
Bₘₑₘ represents a memory bandwidth, and
Bₙₑₜ represents a network bandwidth.

11. The device of claim 10, wherein the processor connects the memory module to the CPU module on the basis of the number of priorities at the time of performing the scheduling.

12. The device of claim 10, wherein the processor connects the memory module to the CPU module when the number of output ports is smaller than Pmax at the time of performing the scheduling.

13. The device of claim 8, wherein the request queue and the response queue include a virtual output queue (VoQ).

14. The device of claim 8, wherein the number (Pₘₐₓ) of priorities not considering the response queue is expressed as shown in the following equation,
$${P}_{max} = ⌈ \frac{{B}_{mem} / {B}_{net}}{{S}_{resp} / {S}_{req}} ⌉ = ⌈ \frac{{T}_{req}}{{T}_{mem}} ⌉ \qquad [ Equation ]$$
S_{req} represents a size of the request message stored in the request queue,
Sᵣₑₛₚ represents a size of the response message stored in the response queue,
Bₘₑₘ represents a memory bandwidth,
Bₙₑₜ represents a network bandwidth,
T_{req} represents a transmission time taken to transfer the request message using the network bandwidth (T_{req}=S_{req}/Bₙₑₜ), and
Tₘₑₘ represents a transmission time taken to transfer the response message using the memory bandwidth (Tₘₑₘ=Sᵣₑₛₚ/Bₘₑₘ).
